(19) United States
(12) Patent Application Publication
(10) Pub. No.: US 2025/0366389 A1
(43) Pub. Date: Dec. 4, 2025

(54) BAIL BAR DETECTION FOR A LAWNMOWER

(71) Applicant: Milwaukee Electric Tool Corporation, Brookfield, WI (US)

(72) Inventors: Daniel R. Ertl, Brookfield, WI (US); Caleb N. Hille, West Chester, OH (US); Tyler L. Graham, Milwaukee, WI (US); Christopher S. Bullington, Milwaukee, WI (US)

(21) Appl. No.: 19/300,022

(22) Filed: Aug. 14, 2025

Related U.S. Application Data
(63) Continuation of application No. 17/885,438, filed on Aug. 10, 2022.
(60) Provisional application No. 63/231,400, filed on Aug. 10, 2021.

(51) Int. Cl. A01D 34/00; A01D 34/68; A01D 34/69; A01D 34/78; A01D 34/82; A01D 101/00

(52) U.S. Cl. CPC A01D 34/006; A01D 34/6812; A01D 34/69; A01D 34/78; A01D 34/824; A01D 2034/6843; A01D 2101/00

(57) ABSTRACT

A battery powered lawnmower having a blade motor coupled to at least one blade, an input configured to receive an activation input from a user, and a bail control bar. The bail control bar is coupled to a position sensor configured to determine a position of the bail control bar. The battery powered lawnmower further includes a controller coupled to the position sensor and configured to control an operation of the blade motor. The controller is configured to receive a blade motor control command resulting from the activation input received by the input, and determine a position of the bail control bar based on data provided by the position sensor. The controller is further configured to, in response to determining that the bail control bar is in a closed position, control the blade motor based on the received blade motor control command.

### CROSS-REFERENCE TO RELATED APPLICATIONS

The present application is a continuation of U.S. patent application Ser. No. 17/885,438, filed on Aug. 10, 2022, which claims the benefit of U.S. Provisional Patent Application No. 63/231,400, filed Aug. 10, 2021, the entire contents of which are hereby incorporated by reference.

### SUMMARY

Electronic lawnmowers, and specifically battery powered lawnmowers, are becoming more prevalent in use by both homeowners and commercial landscapers alike. Safety is a concern for both gas powered and electric lawnmowers, and a bail bar may be used to ensure that the blades and/or drive motors are not allowed to rotate when the bail bar is not being gripped by a user. Generally, a mechanical linkage is used to couple the bail bar to the prime mover. However, electrical lawnmowers do not generally have a fuel-cutoff or other mechanical mechanism to allow for the bail bar to stop operation of the lawnmower. Accordingly, an electronic system may be beneficial for use with an electronic lawnmower.

Embodiments described herein relate to systems for monitoring a position of a bail control bar of a battery powered lawnmower.

Battery powered lawnmowers described herein include a blade motor coupled to at least one blade, an input configured to receive a blade motor control signal, a bail control bar, and a position sensor. The position sensor is configured to determine a position of the bail control bar. The lawnmowers also include a controller coupled to the position sensor and configured to control an operation of the blade motor. The controller is configured to receive a blade motor control command, determine a position of the bail control bar based on data provided by the position sensor, and, in response to determining that the bail control bar is in a closed position, control the blade motor based on the received blade motor control command.

Methods of operating a battery powered lawnmower described herein include receiving, at a controller of the battery powered lawnmower, a blade motor control command from one or more inputs, and determining, by the controller, a position of a bail control bar based on a position signal provided by a position sensor configured to detect the position of the bail control bar. The methods also include controlling, via the controller, the blade motor based on the received blade motor control command in response to determining that the bail control bar is in a closed position.

Battery powered lawnmowers described herein include a blade motor coupled to at least one blade, an input configured to receive a blade motor control signal, a bail control bar, and a handle assembly including a handle housing and a handle. The handle includes a recessed portion configured to receive the bail control bar where the bail control bar is in the closed position. The lawnmowers further include a Hall effect sensor assembly configured to determine a position of the bail control bar. The Hall effect sensor assembly includes a Hall effect sensor and a magnet. The lawnmowers also include a controller coupled to the position sensor and configured to control an operation of the blade motor. The controller is configured to receive a blade motor control command, determine a position of the bail control bar based on data provided by the position sensor, and, in response to determining that the bail control bar is in a closed position, control the blade motor based on the received blade motor control command.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

### BRIEF DESCRIPTION OF THE DRAWINGS

FIG. 1 is a lawnmower, according to some embodiments.

FIGS. 2A-2B are perspective views of a handle of the lawnmower of FIG. 1, according to some embodiments.

FIG. 3A is a front view of the handle of FIGS. 2A-2B, with the bail control bar in the closed position, according to some embodiments.

FIG. 3B is a side view of handle of FIGS. 2A-2B, according to some embodiments.

FIG. 4A is a front view of the handle of FIGS. 2A-2B, with the bail control bar in the open position, according to some embodiments.

FIG. 4B is a side view of the handle of FIGS. 2A-2B, with the bail control bar in the open position, according to some embodiments.

FIG. 5 is a block diagram of a control system for the lawnmower of FIG. 1, according to some embodiments.

FIG. 6 is a perspective view of a battery pack, according to some embodiments.

FIG. 7 is a block diagram of a control system for the battery pack of FIG. 6, according to some embodiments.

FIG. 8 illustrates a system diagram for use with the bail bar detection, according to some embodiments.

FIGS. 9A and 9B illustrate magnet movement relative to a sensor for bail bar detection.

FIG. 10 illustrates a state machine for an operator presence device (“OPD”) system, according to various embodiments.

FIG. 11 is a flow chart illustrating a process for controlling the electric lawnmower of FIG. 1.

### DETAILED DESCRIPTION

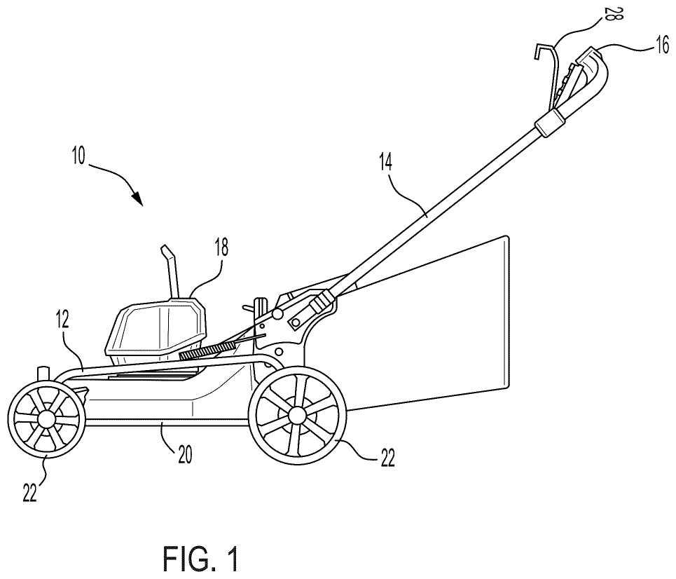

FIG. 1 illustrates a lawnmower 10, according to one embodiment. The lawnmower 10 includes a housing 12 and a handle 16 coupled to the housing 12 by support beams 14. A motor housing 18 is coupled to an upper portion of the housing 12 and houses a blade motor configured to drive the cutting blades 20. The blades 20 are coupled to a lower portion of the housing 12. The lawnmower 10 includes a plurality of wheels 22, in which one or more of the wheels 22 may be driven by the blade motor and/or an auxiliary motor, as described in more detail below. In some embodiments, the plurality of wheels 22 are driven by an auxiliary motor within the motor housing 18.

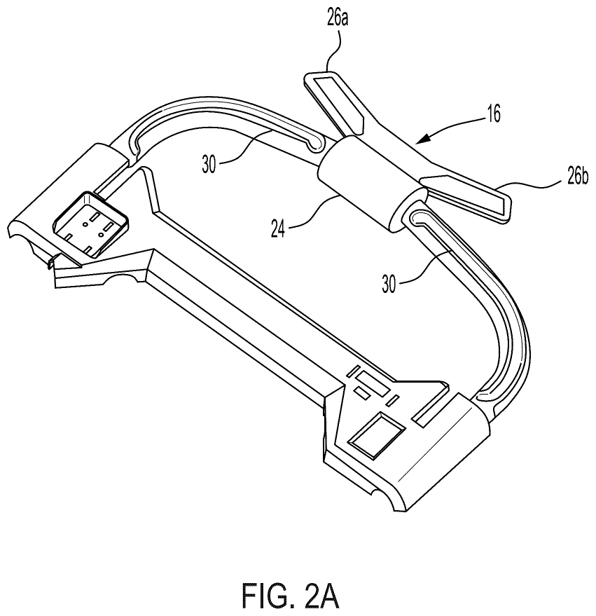

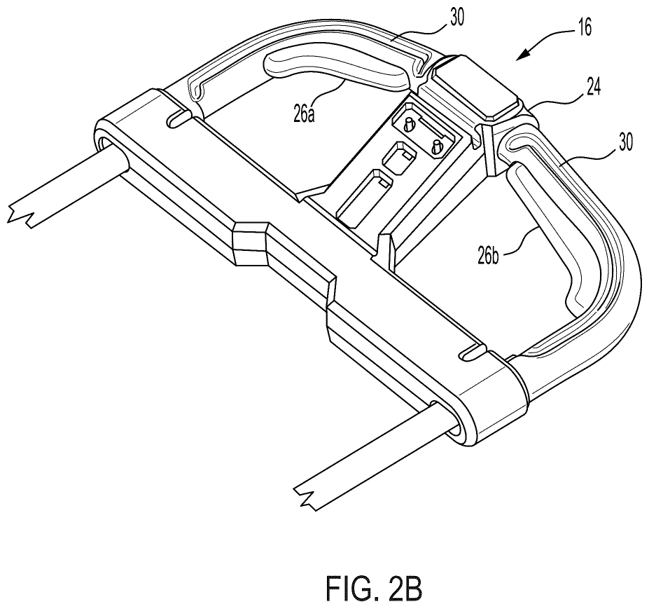

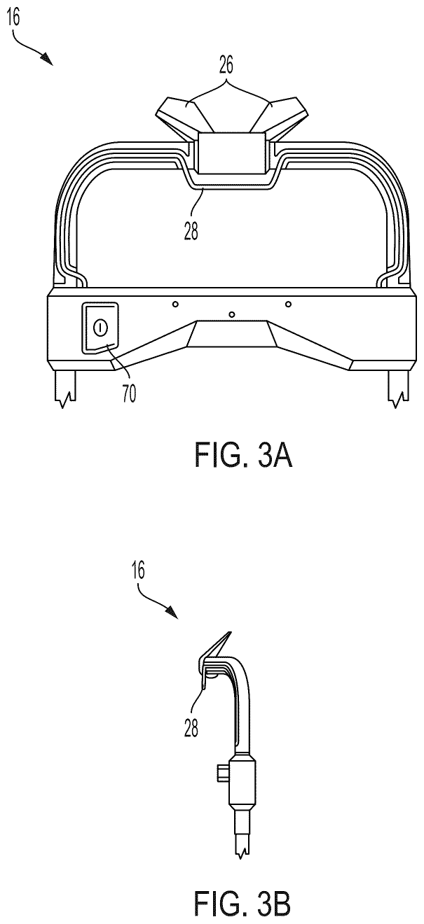

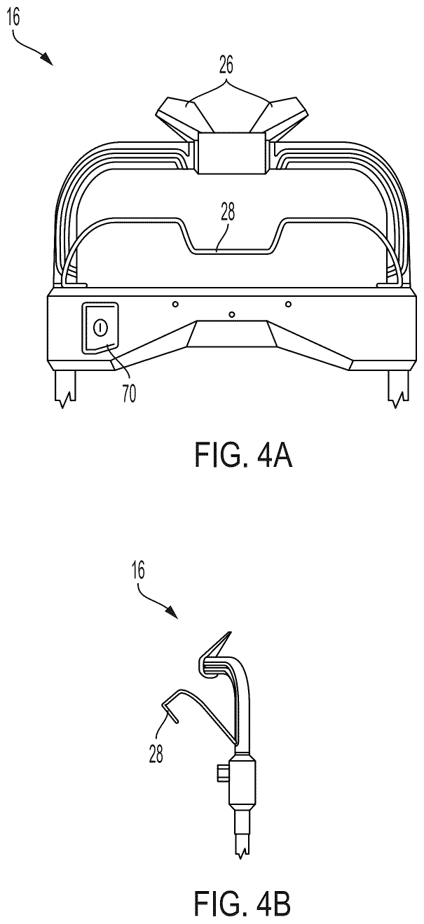

FIGS. 2A-2B illustrate the handle 16, according to some embodiments. The handle 16 includes a handle housing 24. A first paddle 26a and a second paddle 26b (e.g., paddles 26) extend from the handle housing 24 and act as a switch or trigger. Accordingly, operation of the first paddle 26a and the second paddle 26b may drive the blade motor and/or the auxiliary motor, as described in more detail below. The handle 16 may further include a bail control bar 28. In some embodiment, the bail control bar 28 may fit within a recessed portion 30 of the handle 16 when in the closed position, as shown in in FIG. 2B, thereby allowing the bail control bar 28 to be substantially flush with the handle 16 during operation of the lawnmower 10. The handle 16 may further include an input 70 (best seen in FIGS. 3A and 4A) for blade activation control. The input 70 may be a switch or other user input. The paddles 26 may be used (via user actuation) for drive motor activation control. Blade motor activation control may be implemented by the input 70.

Turning now to FIG. 3A, a front view of the handle 16 is shown, according to some embodiments. The input 70 may be arranged on a front side of the handle 16. As shown in FIG. 3A, the bail control bar 28 is in a closed position, such as when gripped by a user. FIG. 3B is a side view of the handle 16 with the bail control bar 28 in the closed position. FIGS. 4A-4B illustrated a front view and side view, respectively, of the handle 16 with the bail control bar 28 in the open position, according to some embodiments. In one embodiment, the bail control bar 28 is spring-biased towards the open position, thereby requiring a user to grip the bail control bar 28 to maintain the bail control bar 28 in the closed position.

As will be described in more detail below, the bail control bar 28 is coupled to a controller of the lawnmower 10, and is configured as a failsafe device, such that a user must maintain the bail control bar 28 in the closed position in order to initiate operation of a blade motor and/or drive motors. Furthermore, upon release of the bail control bar 28 causing the bail control bar 28 to transition to the open position, the controller will stop operation of the blade and/or drive motors, as will be described in more detail below.

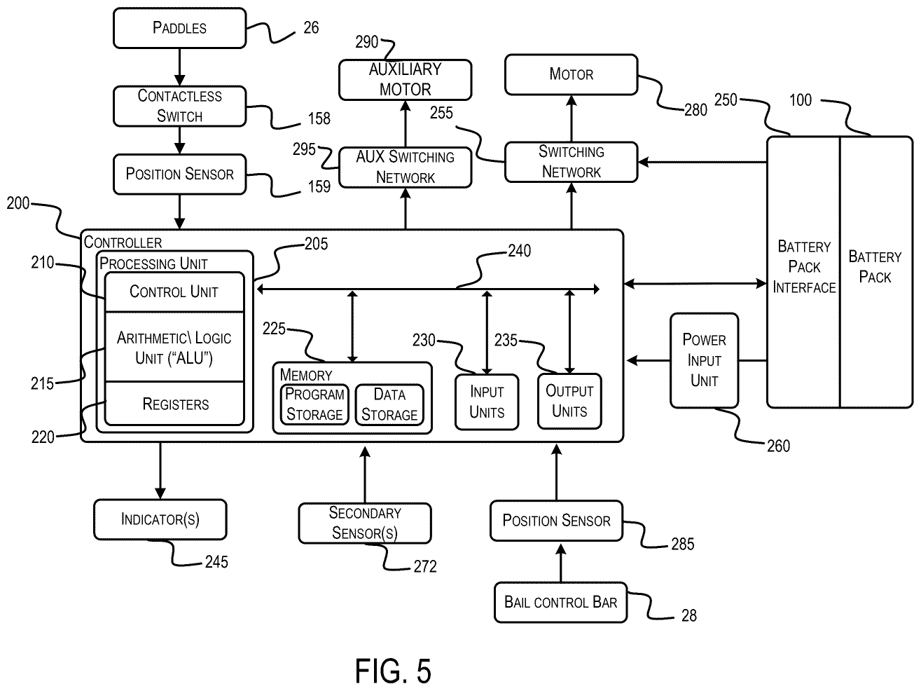

A controller 200 for the lawnmower 10 is illustrated in FIG. 5. The controller 200 is electrically and/or communicatively connected to a variety of modules or components of the lawnmower 10. For example, the illustrated controller 200 is connected to indicators 245, secondary sensor(s) 272 (e.g., a speed sensor, a voltage sensor, a temperature sensor, a current sensor, etc.), the paddles 26 (via a contactless switch 158 and a position sensor 159), the bail control bar 28 (via one or more position sensors 285) a power switching network 255, and a power input unit 260.

The controller 200 includes a plurality of electrical and electronic components that provide power, operational control, and protection to the components and modules within the controller 200 and/or lawnmower 10. For example, the controller 200 includes, among other things, a processing unit 205 (e.g., a microprocessor, an electronic processor, an electronic controller, a microcontroller, or another suitable programmable device), a memory 225, input units 230, and output units 235. The processing unit 205 includes, among other things, a control unit 210, an arithmetic logic unit (“ALU”) 215, and a plurality of registers 220 (shown as a group of registers in FIG. 5) and is implemented using a known computer architecture (e.g., a modified Harvard architecture, a von Neumann architecture, etc.). The processing unit 205, the memory 225, the input units 230, and the output units 235, as well as the various modules connected to the controller 200 are connected by one or more control and/or data buses (e.g., common bus 240). The control and/or data buses are shown generally in FIG. 5 for illustrative purposes. The use of one or more control and/or data buses for the interconnection between and communication among the various modules and components would be known to a person skilled in the art in view of the embodiments described herein.

The memory 225 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 205 is connected to the memory 225 and executes software instructions that are capable of being stored in a RAM of the memory 225 (e.g., during execution), a ROM of the memory 225 (e.g., on a generally permanent basis), or another non-transitory computer readable medium such as another memory or a disc. Software included in the implementation of the lawnmower 10 can be stored in the memory 225 of the controller 200. The software includes, for example, firmware, one or more applications, program data, filters, rules, one or more program modules, and other executable instructions. The controller 200 is configured to retrieve from the memory 225 and execute, among other things, instructions related to the control processes and methods described herein. In other embodiments, the controller 200 includes additional, fewer, or different components.

The controller 200 drives the motor 280 to rotate the blades 20 in response to a user's actuation of the paddles 26. In some examples, the motor 280 is referred to as the blade motor. Depression of the paddles 26 actuates the contactless switch to indicate that the paddles 26 are being depressed. The paddle position sensors 159 are configured to sense a position of the paddles 26 (e.g., the magnitude of depression of the paddles), which outputs a signal to the controller 200 to drive the motor 280, and therefore the blades 20. In some embodiments, the controller 200 is configured to control a power switching network 255 (e.g., a field-effect transistor (“FET”) switching bridge) to drive the motor 280 in response to the sensed values received from the position sensors 159 and/or contactless switch 158. For example, the power switching network 255 may include a plurality of high side switching elements (e.g., FETs) and a plurality of low side switching elements. The controller 200 may control each of the plurality of high side switching elements and the plurality of low side switching elements to drive each phase of the motor 280.

In response to determining that the paddles 26 are released, the controller 200 may be configured to control the power switching network 255 to apply a braking force to the motor 280. For example, the power switching network 255 may be controlled to more quickly deaccelerate the motor 280.

In some embodiments, the controller 200 is configured to drive an auxiliary motor 290, also referred to as a drive motor 290, which may be configured to drive the plurality of wheels 22. For example, the motor 280 is controlled to drive the blades 20, and the auxiliary motor 290 is controlled to drive the plurality of wheels 22 to provide a power drive functionality to the lawnmower 10. The auxiliary motor may be controlled via an auxiliary power switching network 295.

The indicators 245 are also connected to the controller 200 and receive control signals from the controller 200 to turn on and off or otherwise convey information based on different states of the lawnmower 10. The indicators 245 include, for example, one or more light-emitting diodes (LEDs), or a display screen. The indicators 245 can be configured to display conditions of, or information associated with, the lawnmower 10. For example, the indicators 245 may be configured to provide an indication of whether the lawnmower 10 is in a condition to allow the user to activate the motor 280 and/or the auxiliary motor 290, such as when the bail control bar 28 is in the closed position.

The battery pack interface 250 is connected to the controller 200 and is configured to couple with the battery pack 100. The battery pack interface 250 includes a combination of mechanical (e.g., a battery pack receiving portion) and electrical components configured to and operable for interfacing (e.g., mechanically, electrically, and communicatively connecting) the lawnmower 10 with the battery pack 100. The battery pack interface 250 is coupled to the power input unit 260. The battery pack interface 250 transmits the power received from the battery pack 100 to the power input unit 260. The power input unit 260 includes active and/or passive components (e.g., voltage step-down controllers, voltage converters, rectifiers, filters, etc.) to regulate or control the power received through the battery pack interface 250 and to the controller 200. In some embodiments, the battery pack interface 250 is also coupled to the power switching network 255. The operation of the power switching network 255, as controlled by the controller 200, determines how power is supplied to the motor 280.

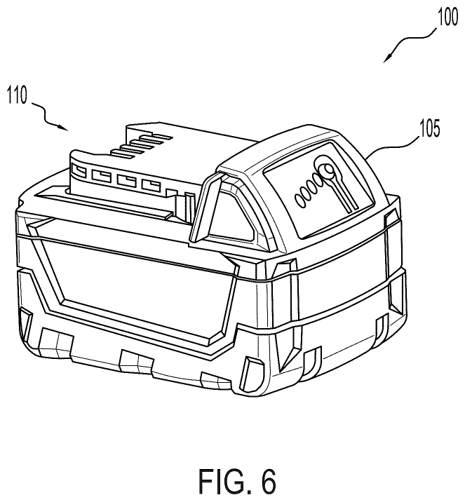

As described above, in some embodiments, the lawnmower 10 is a battery-powered lawnmower. FIG. 6 illustrates a battery pack 100 that includes a housing 105 and a battery pack interface 110 for connecting the battery pack 100 to a device, such as the lawnmower 10.

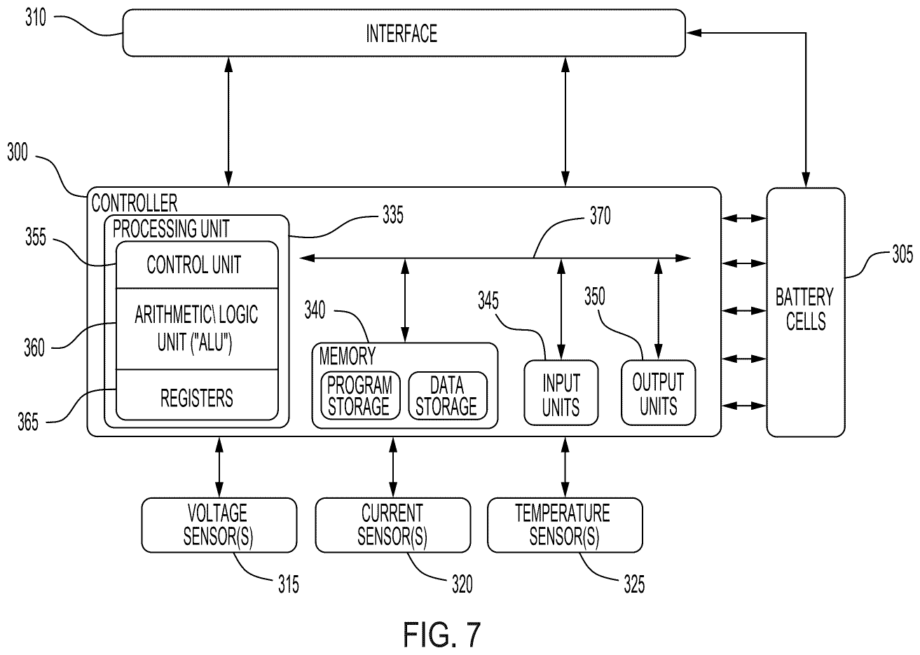

FIG. 7 illustrates a control system for the battery pack 100. The control system includes a battery pack controller 300. The battery pack controller 300 is electrically and/or communicatively connected to a variety of modules or components of the battery pack 100. For example, the illustrated battery pack controller 300 is connected to one or more battery cells 305 and an interface 310 (e.g., the battery pack interface 110 of the battery pack 100 illustrated in FIG. 12). The battery pack controller 300 is also connected to one or more voltage sensors or voltage sensing circuits 315, one or more current sensors or current sensing circuit 320, and one or more temperature sensors or temperature sensing circuits 325. The battery pack controller 300 includes combinations of hardware and software that are operable to, among other things, control the operation of the battery pack 100, monitor a condition of the battery pack 100, enable or disable charging of the battery pack 100, enable or disable discharging of the battery pack 100, etc.

The battery pack controller 300 includes a plurality of electrical and electronic components that provide power, operational control, and protection to the components and modules within the battery pack controller 300 and/or the battery pack 100. For example, the controller 200 includes, among other things, a processing unit 335 (e.g., a microprocessor, a microcontroller, or another suitable programmable device), a memory 340, input units 345, and output units 350. The processing unit 335 includes, among other things, a control unit 355, an arithmetic logic unit (“ALU”) 360, and a plurality of registers 365 (shown as a group of registers in FIG. 7) and is implemented using a known computer architecture (e.g., a modified Harvard architecture, a von Neumann architecture, etc.). The processing unit 335, the memory 340, the input units 345, and the output units 350, as well as the various modules or circuits connected to the controller 200, are connected by one or more control and/or data buses (e.g., common bus 370). The control and/or data buses are shown generally in FIG. 7 for illustrative purposes. The use of one or more control and/or data buses for the interconnection between and communication among the various modules, circuits, and components would be known to a person skilled in the art in view of the invention described herein.

The memory 340 is a non-transitory computer readable medium and includes, for example, a program storage area and a data storage area. The program storage area and the data storage area can include combinations of different types of memory, such as a read-only memory (“ROM”), a read-only memory (RAM) (e.g., dynamic RAM (“DRAM”), synchronous DRAM (“SDRAM”), etc.), electrically erasable programmable ROM (“EEPROM”), flash memory, a hard disk, an secure digital (“SD”) card, or other suitable magnetic, optical, physical, or electronic memory devices. The processing unit 335 is connected to the memory 340 and executes software instructions that are capable of being stored in a RAM of the memory 340 (e.g., during execution), a ROM of the memory 340 (e.g., on a generally permanent basis), or another non-transitory computer readable medium such as another memory or a disc. Software included in the implementation of the battery pack 100 can be stored in the memory 340 of the controller 300. The software includes, for example, firmware, one or more applications, program data, filters, rules, one or more program modules, and other executable instructions. The battery pack controller 300 is configured to retrieve from the memory 340 and execute, among other things, instructions related to the control processes and methods described herein. In other constructions, the battery pack controller 300 includes additional, fewer, or different components.

The interface 310 includes a combination of mechanical components (e.g., rails, grooves, latches, etc.) and electrical components (e.g., one or more terminals) configured to and operable for interfacing (e.g., mechanically, electrically, and communicatively connecting) the battery pack 100 with another device (e.g., a power tool, a battery pack charger, the lawnmower 10, etc.). For example, the interface 310 is configured to receive power via a power line between the one or more battery cells 305 and the interface 310. The interface 310 is also configured to communicatively connect to the battery pack controller 300.

As noted above, the bail control bar 28 is configured to prevent operation of the motor 280 and/or auxiliary motor 290 in response to the bail control bar 28 being in the open position. One or more sensors 285 provide an indication of the position of the bail control bar 28 to the controller 200. In one embodiment, the one or more sensors 285 may include a Hall effect sensor; however, other sensors, such as proximity sensors, inductive sensors, contact switches, reed switches, and/or other sensors may be used to provide data to the controller 200 indicative of the position of the bail control bar 28.

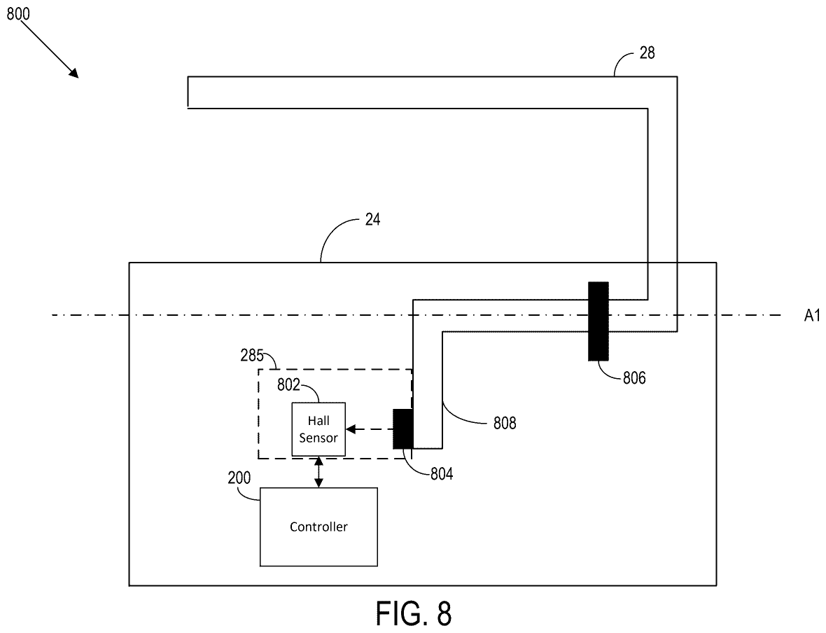

Turning now to FIG. 8, a sensing system 800 integrated with the bail control bar 28 is shown, according to some embodiments. As shown in FIG. 8, the bail control bar 28 and the sensor 285 are contained in the handle housing 24 of the lawnmower 10. As described above, the sensor 285 may be a hall-effect sensor assembly having a Hall sensor 802 and an associated magnet 804. The position of the bail control bar 28 will place the magnet in front of the Hall effect sensor 802 when the bail control bar 28 is in a closed position. The magnet is moved away from and out of range of the sensor when the bail control bar 28 is in an open position. The sensor may be located in a main part (e.g., a top end user holding portion) of the handle 16, for example, centered in the main part/holding portion of the handle 16.

The bail control bar 28 is configured to rotate about an axis of rotation A1 at an associated rotation point 806. The magnet 804 is coupled to a linkage 808 of the bail control bar 28 and is configured to move along with a movement of the bail control bar 28 with respect to the hall sensor 802. For example, the bail control bar's 28 axis of rotation A1 and rotation point 806 are linked to the magnet 804 and cause the magnet 804 to move between open and closed positions with respect to the hall sensor 802. The magnet 804 may be moved between a closed position of the bail control bar 28 (where the magnet is in range of/detectable by the sensor) and an open position (where the magnet is not in range of/not detectable by the Hall effect sensor 802). The controller 200 of the lawnmower receives the signal from sensor 285 (e.g., via a user interface cable), and is able to determine/detect whether the bail control bar 28 is in the closed position or the open position.

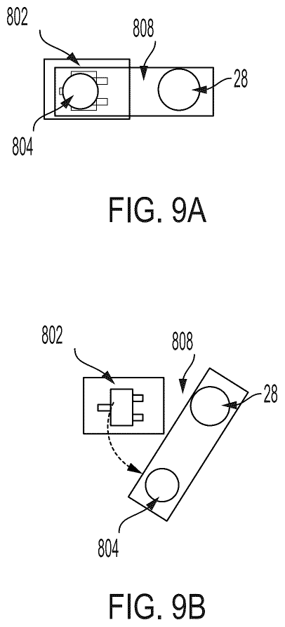

FIGS. 9A and 9B illustrate the operation of the Hall effect sensor 802 and magnet 804 described above with respect to FIG. 8. As shown in FIG. 9A, the bail control bar 28 is in the closed position (e.g., being gripped by a user to facilitate operation of the lawnmower 10), placing the magnet 804 in proximity to the Hall effect sensor 802. As shown in more detail in FIG. 9A, the magnet 804 is attached to the linkage 808 such that rotation of the bail control bar 28 causes rotation of the linkage 808, thereby altering the position of the magnet 804 with respect to the Hall effect sensor 802. In some embodiments, the bail control bar 28 may include a feature to fix the bail control bar 28 in place and allow it to rotate on one axis. Accordingly, movement of the bail control bar 28 into the closed position causes the linkage 808 to rotate, such that the magnet 804 is placed within the sensing/detecting proximity of the sensor. This positioning of the magnet 804 generates a magnetic field which is detectable by the Hall effect sensor 802. Depending on the strength of the magnetic field detected by the Hall effect sensor 802, which in turn correlates to the position of the magnet 804 and vis-à-vis the bail control bar, the Hall effect sensor 802 outputs a signal to the controller 200 indicating whether the bail control bar 28 is in an open position or a closed position. In some examples, the Hall effect sensor 802 may be configured such that the magnet 804 must be substantially aligned (e.g., greater than 90% alignment) with the Hall effect sensor 802, such as shown in FIG. 9A.

Conversely, FIG. 9B shows the bail control bar 28 in an open position (e.g., released or not fully gripped by a user), thereby rotating the magnet 804 into a position removed from a face 812 of the Hall effect sensor 802. This reduces and/or eliminates strength of the magnetic field detected by the Hall effect sensor 802. In response to the strength of the magnetic field falling below a threshold value, the Hall effect sensor 802 may provide a signal to the controller 200 indicating that the bail control bar 28 is in the open position. In some embodiments, the Hall effect sensor 802 may only provide a signal to the controller 200 when the Hall effect sensor 802 determines that the bail control bar 28 is in the closed position. In still further examples, the Hall effect sensor 802 may send raw data indicative of the sensed magnetic field directly to the controller 200, which may then determine whether the bail control bar 28 is in the open or closed position. In still other examples, such as where other or additional sensors are used to determine a position of the bail control bar 28, various data points may be sent to the controller by the various sensors to provide an indication of the position of the bail control bar 28, as required for a given application.

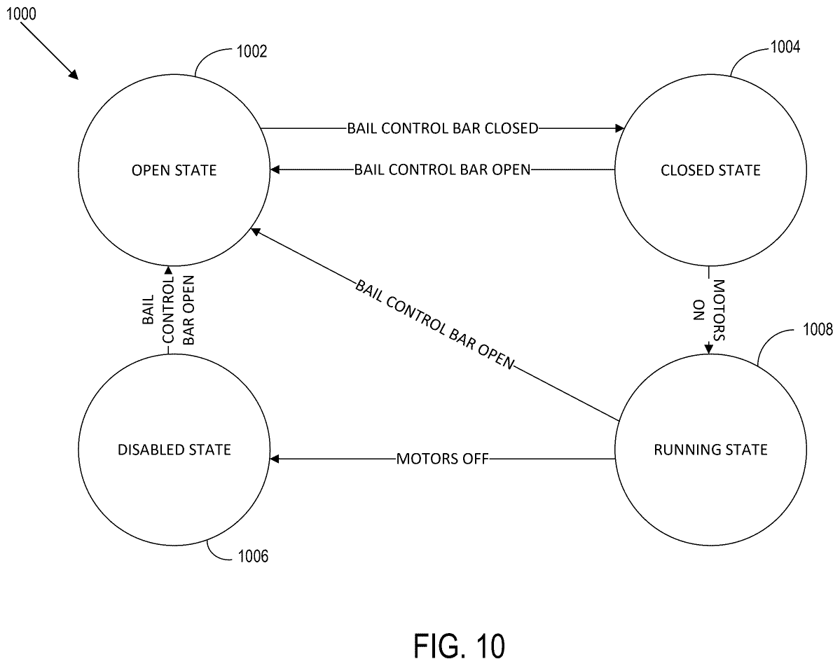

FIG. 10 illustrates a state machine 1000 for an operator presence device (“OPD”) system, according to various embodiments. The OPD may include the combined system (bail control bar 28, magnet 804, Hall effect sensor 802, etc.). In response to the magnet 804 being in the sensing range of the Hall effect sensor 802 (e.g., when the bail control bar 28 is in a closed position), the Hall effect sensor 802 may output a logic low (e.g., 0V) signal to the controller 200. In response to the magnet 804 being out of the sensing range of the sensor (e.g., when the bail control bar 28 is in an open position), the Hall effect sensor 802 may output a logic high (e.g., 3.3V) signal. In some embodiments, the Hall effect sensor 802 is omni-polar, such that when a strong north or south pole is detected, the output signal is driven to logic low. Otherwise, when no strong magnetic field (e.g., above a minimum strength threshold) is detected, the output is logic high.

The output signal from the Hall effect sensor 802 may be processed by the controller 200 to allow the drive or blade motors to be activated via their respective controls (when the bail control bar 28 is in the closed position) or allow the motors to be disabled (when the bail control bar 28 is in an open position) regardless of the state of the respective controls of the motors in the system. FIG. 10 shows four different internal states for the OPD system: an OPEN state 1002, a CLOSED state 1004, a DISABLED state 1006, and a RUNNING state 1008.

The lawnmower 10 may operate in the OPEN state 1002 where the bail control bar 28 is in an open position. In the OPEN state 1002 the bail control bar 28 is open and the blade motor 280 and the auxiliary (e.g., drive) motor 290 are deactivated. The OPEN state 1002 may occur when the lawnmower 10 is not being used, or during a reset condition. Upon the bail control bar 28 being moved to the closed position, and the lawnmower 10 being put in an active state (e.g., having battery power, or receiving an activation input from a user, such as via one or more of the paddles 26, the input 70, and/or one more inputs received via the input units 230), the lawnmower 10 transitions to the CLOSED state 1004. In the CLOSED state 1004, the blade motor 280 and/or auxiliary motors 290 are in an active state and can be operated in response to receiving an input, such as via the paddles 26. In response to the bail control bar 28 transitioning to the open position, the lawnmower 10 will return directly to the OPEN state 1002.

From the CLOSED state 1004, the lawnmower 10, upon receiving an input to activate either the blade motor 280 and/or the auxiliary motor 290, enters the RUNNING state 1008, wherein one or both of the blade motor 280 and/or the auxiliary motor 290 are operating (e.g., driving their respective loads). In response to the bail control bar 28 transitioning to the open position, the lawnmower 10 will return directly to the OPEN state 1002. In response to the blade motor 280 being transitioned to an OFF condition (e.g., the user disables the blade motor), the lawnmower 10 enters the DISABLED state, wherein only the auxiliary motor 290 may be operable. In response to the bail control bar 28 transitioning to the open position, the lawnmower 10 will return directly to the OPEN state.

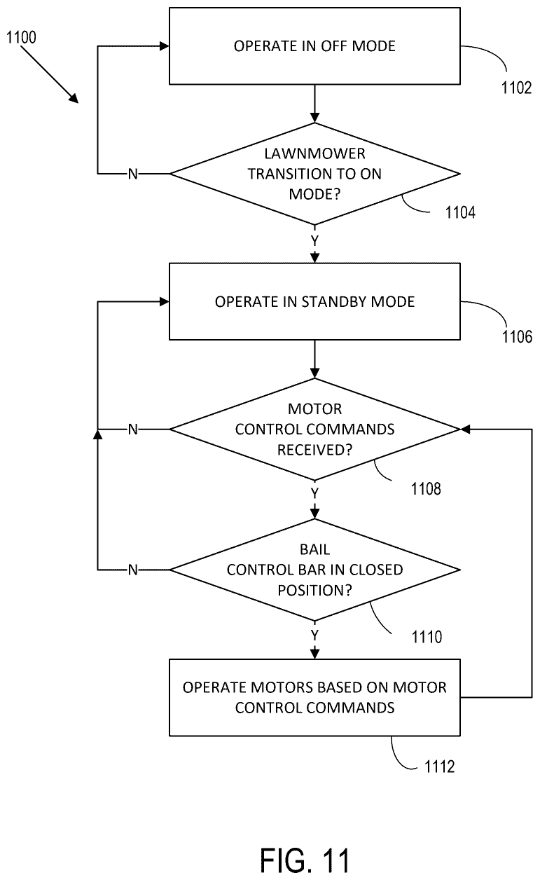

Turning now to FIG. 11, a process 1100 for controlling the lawnmower 10 having the bail control bar 28 described above, is shown, according to some embodiments. In one embodiment, the process 1100 is performed by the controller 200. In one embodiment the process may be stored as instructions in the memory 225 and may be executed by the processing unit 205.

At process block 1102, the lawnmower 10 operates in an OFF mode. At process block 1104, the controller 200 determines whether the lawnmower 10 is in an ON mode. The ON mode may be initiated by a user providing an input to the controller 200, such as via the contactless switch 158 of the paddles 26 and/or activation of the input 70, i.e., to implement control of the motor 290 and/or motor 280. In response to determining that the lawnmower is not in the ON mode, the lawnmower 10 remains in the OFF mode at process block 1102. In some embodiments, the OFF mode may be similar to the OPEN state 1002 described above. In response to determining that the lawnmower 10 is in the ON mode, the controller 200 transitions the lawnmower into a standby mode at process block 1108. The standby mode may be similar to the CLOSED state 1004 described above. For example, when operating in the standby mode, the lawnmower may be in an active condition (e.g., the controller 200 is active and ready to control one or more operations, such as motor rotation, of the lawnmower 10) and waiting for a user input to control one or more operations of the lawnmower, such as controlling rotation of the blade motor 280 and/or the auxiliary motor 290.

At process block 1110, the controller 200 determines whether one or more motor control commands have been received. The motor control commands may be received via the contactless switch 158 and/or position sensor 159. However, the motor control commands may also be received from one or more of the secondary sensor(s) 272, and/or via an input to the input units 230 of the controller 200. The motor control commands may be provided for the blade motor 280, the auxiliary (drive) motor 290, or both. In response to determining that no motor control command was received, the controller 200 continues to operate the lawnmower 10 in the standby mode at process block 1108. The motor control commands may provide a desired motor speed, a rotation direction, and/or other signal as required for a given application.

In response to determining that one or more motor control commands were received at the controller 200, the controller 200 then determines a position of the bail control bar 28 at process block 1112. Specifically, the controller 200 determines whether the bail control bar 28 is in a closed position (e.g., being gripped by a user) or in an open position. As described above, the controller 200 may determine a position of the bail control bar 28 based on information from the one or more position sensors 285, such as the Hall effect sensor 802 described above. In response to determining that the bail control bar 28 is in the open position, the controller 200 resumes operating the lawnmower 10 in the standby mode at process block 1108. In some examples, the controller 200 may provide an indication to a user, such as via the indicators 245, that the bail control bar 28 is not in the closed position, thereby preventing operation of the blade motor 280 and/or auxiliary motor 290. In response to the controller 200 determining that the bail control bar 28 is in the closed position, the controller 200 operates (e.g., rotates) the motors (i.e., the blade motor 280, the auxiliary motor 290, or a combination thereof) based on the received motor control commands. The controller 200 then returns to process block 1110 such that any changes to the motor control commands and/or change in position of the bail control bar are reflected in the operation of the lawnmower 10. For example, upon the bail control bar 28 moving from the closed position to the open position, the controller 200 stops rotation of the blade motor 280 and/or the drive motor 290.

What is claimed is:

1. A battery powered lawnmower comprising:
a blade motor coupled to at least one blade;
an input configured to receive an activation input from a user;
a bail control bar;
a position sensor configured to determine a position of the bail control bar; and
a controller connected to the position sensor and configured to control an operation of the blade motor, the controller configured to:
receive a blade motor control command resulting from the activation input received by the input,
determine the position of the bail control bar based on a signal output by the position sensor, and
control, in response to determining that the bail control bar is in a closed position, the blade motor based on the received blade motor control command.

2. The battery powered lawnmower of claim 1, wherein the position sensor is a Hall effect sensor assembly including a Hall effect sensor and a magnet.

3. The battery powered lawnmower of claim 2, wherein the bail control bar is coupled to a handle assembly of the battery powered lawnmower via a linkage, and
wherein the magnet is coupled to the linkage and configured to rotate with respect to the Hall effect sensor in response to the bail control bar being moved between one of the closed position and an open position.

4. The battery powered lawnmower of claim 3, wherein the magnet is configured to be positioned closest to the Hall effect sensor where the bail control bar is in the closed position.

5. The battery powered lawnmower of claim 1, further comprising:
a handle, wherein the handle includes a recessed portion configured to receive the bail control bar when the bail control bar is in the closed position.

6. The battery powered lawnmower of claim 1, further comprising:
a plurality of wheels; and
a drive motor coupled to at least one of the plurality of wheels and configured to rotate the plurality of wheels in at least one direction.

7. The battery powered lawnmower of claim 6, further comprising paddles configured to activate the drive motor.

8. The battery powered lawnmower of claim 6, wherein the controller is further configured to:
receive a drive motor control command;
determine the position of the bail control bar based on the signal output by the position sensor; and
control, in response to determining that the bail control bar is in the closed position, the drive motor based on the received drive motor control command.

9. The battery powered lawnmower of claim 1, wherein the controller is further configured to:
detect a transition of the bail control bar from the closed position to an open position based on the signal output by the position sensor; and
stop the operation of the blade motor based on detecting the bail control bar transitioning to the open position.

10. A method of operating a battery powered lawnmower, the method comprising:
receiving, at a controller of the battery powered lawnmower, a blade motor control command from one or more inputs;
determining, by the controller, a position of a bail control bar based on a position signal provided by a position sensor configured to detect the position of the bail control bar; and
controlling, via the controller, a blade motor based on the received blade motor control command in response to determining that the bail control bar is in a closed position.

11. The method of claim 10, wherein the position sensor is a Hall effect sensor assembly including a Hall effect sensor and a magnet.

12. The method of claim 11, wherein the bail control bar is coupled to a handle assembly of the battery powered lawnmower via a linkage, and wherein the magnet is coupled to the linkage to rotate with respect to the Hall effect sensor in response to the bail control bar being moved between one of the closed position and an open position.

13. The method of claim 12, wherein the magnet is configured to be positioned closest to the Hall effect sensor where the bail control bar is in the closed position.

14. The method of claim 10, wherein the battery powered lawnmower further includes a handle, wherein the handle includes a recessed portion configured to receive the bail control bar in the closed position.

15. The method of claim 10, further comprising:
receiving a drive motor control command;
determining the position of the bail control bar based on the position signal; and
controlling a drive motor based on the received drive motor control command in response to determining that the bail control bar is in the closed position.

16. The method of claim 15, further comprising driving, using the drive motor, one or more wheels coupled to the battery powered lawnmower.

17. The method of claim 10, further comprising:
detecting a transition of the bail control bar from the closed position to an open position based on the position signal;
stopping an operation of the blade motor based on detecting the bail control bar transitioning to the open position.

18. A battery powered lawnmower comprising:
a blade motor coupled to at least one blade;
an input configured to receive an activation input from a user;
a bail control bar;
a handle assembly including a handle housing and a handle, wherein the handle includes a recessed portion configured to receive the bail control bar when the bail control bar is in a closed position;
a Hall effect sensor assembly configured to determine a position of the bail control bar, wherein the Hall effect sensor assembly includes a Hall effect sensor and a magnet; and
a controller connected to the Hall effect sensor and configured to control an operation of the blade motor, the controller is configured to:
receive a blade motor control command resulting from the activation input received by the input,
determine the position of the bail control bar based on a signal output by the Hall effect sensor, and
control, in response to determining that the bail control bar is in the closed position, the blade motor based on the received blade motor control command.

19. The battery powered lawnmower of claim 18, wherein the bail control bar is coupled to the handle housing via a linkage, and wherein the magnet is coupled to the linkage and configured to rotate with respect to the Hall effect sensor in response to the bail control bar being moved between one of the closed position and an open position.

20. The battery powered lawnmower of claim 19, wherein the magnet is configured to be positioned closest to the Hall effect sensor when the bail control bar is in the closed position.

21. The battery powered lawnmower of claim 18, wherein the controller is further configured to:
detect a transition of the bail control bar from the closed position to an open position based on the signal output by the Hall effect sensor; and
stop the operation of the blade motor based on detecting the bail control bar transitioning to the open position from the closed position.
